(19) United States
(12) Patent Application Publication
(10) Pub. No.: US 2023/0079324 A1
(43) Pub. Date: Mar. 16, 2023

(54) SYSTEMS FOR TARGETING AN OFFER FOR GOODS AND/OR SERVICES TO PROSPECTIVE CUSTOMERS USING PRICE DISCRIMINATION AND RELATED METHODS

(71) Applicant: Daryl Moody, Johns Creek, GA (US)

(72) Inventor: Daryl Moody, Johns Creek, GA (US)

(21) Appl. No.: 17/945,556

(22) Filed: Sep. 15, 2022

Related U.S. Application Data
(60) Provisional application No. 63/244,288, filed on Sep. 15, 2021.

(51) Int. Cl. G06Q 30/02

(52) U.S. Cl. CPC G06Q 30/0261

(57) ABSTRACT

Systems and methods for targeting an offer to prospective customers using price discrimination are described herein. An example system includes a processor and a memory operably coupled to the processor. The system is configured to receive a starting location and a destination from a user; determine a route between the starting location and the destination; and receive a waypoint and customer selection information, where the waypoint and the customer selection information are associated with an advertiser. The customer selection information differentiates between probable and improbable customers. The system is further configured to determine an alternative route between the starting location and the destination, where the alternative route includes the waypoint; determine, using the customer selection information, whether the user is an improbable customer; and if the user is an improbable customer, transmit the alternative route and an offer associated with the advertiser to the user.

### CROSS-REFERENCE TO RELATED APPLICATIONS

This application claims the benefit of U.S. provisional patent application No. 63/244,288, filed on Sep. 15, 2021, and titled “SYSTEMS FOR TARGETING AN OFFER FOR GOODS AND/OR SERVICES TO PROSPECTIVE CUSTOMERS USING PRICE DISCRIMINATION AND RELATED METHODS,” the disclosure of which is expressly incorporated herein by reference in its entirety.

### BACKGROUND

Travelers between two locations are frequently customers of businesses located along their selected route, and travelers frequently have the choice of more than one possible route to reach their destination. Currently, travelers can plan a route between two locations using a system to identify the shortest route (e.g., by distance and/or travel time) between two points, or a route between two points that incorporates certain waypoints. Current advertising systems provide advertising offers to users, generally to incentivize a user to visit a specific location where the advertiser is located. Such systems, however, provide offers to travelers who would have visited the advertiser's business regardless of receiving an offer. In other words, travelers who would have been customers of the advertiser anyway receive unnecessary incentives to patronize the advertiser's business. Therefore, current systems fail to fully use route planning information, advertiser information, and customer information to transmit ideal offers to potential or prospective customers.

To overcome the above, systems and methods that incorporate route planning information, customer information, and/or advertising information would be advantageous. The presently disclosed systems and methods are directed at overcoming one or more of the issues set forth above, and/or other problems in the art.

### SUMMARY

According to one aspect, the present disclosure is direct to a system including a processor and a memory operably coupled to the processor. The memory has computer-executable instructions stored thereon that, when executed by the processor, cause the processor to: receive a starting location and a destination from a user; determine a route between the starting location and the destination; and receive a waypoint and customer selection information. The waypoint and the customer selection information are associated with an advertiser, and the customer selection information differentiates between probable and improbable customers. The memory has further computer-executable instructions stored thereon that, when executed by the processor, cause the processor to: determine an alternative route between the starting location and the destination, where the alternative route includes the waypoint; determine, using the customer selection information, whether the user is a probable customer or an improbable customer; and if the user is an improbable customer, transmit the alternative route and an offer associated with the advertiser to the user.

Additionally, the memory optionally has further computer-executable instructions stored thereon that, when executed by the processor, cause the processor to, if the user is a probable customer, prevent transmission of the offer to the user.

Alternatively or additionally, in some implementations, the customer selection information differentiates between probable and improbable customers based a distance between the waypoint and the route. Optionally, the value of the offer is variable in relation to the distance between the waypoint and the route.

Alternatively or additionally, in other implementations, the customer selection information differentiates between probable and improbable customers based on a probability of becoming a customer of the advertiser. Optionally, the customer selection information includes a threshold probability that differentiates between probable and improbable customers. For example, the threshold probability is optionally selected by the advertiser. In addition, the memory optionally has further computer-executable instructions stored thereon that, when executed by the processor, cause the processor to determine a probability of the user becoming a customer of the advertiser. Optionally, the value of the offer is variable in relation to the probability of the user becoming a customer of the advertiser.

Alternatively or additionally, in some implementations, the memory has further computer-executable instructions stored thereon that, when executed by the processor, cause the processor to: receive an acceptance of the offer from the user; and in response to the acceptance, transmit a token to the user.

Alternatively or additionally, in some implementations, the memory has further computer-executable instructions stored thereon that, when executed by the processor, cause the processor to: receive a confirmation that the user reached the destination; and in response to the confirmation, transmit a token to the user. The confirmation includes location data associated with the user. For example, the location data is acquired by a device associated with the user, and the location data is transmitted to the system via a network.

Alternatively or additionally, in some implementations, the token is at least one of a coupon, discount, rebate, or credit for goods or services associated with the advertiser.

Alternatively or additionally, in some implementations, the step of receiving a waypoint and customer selection information includes receiving a respective waypoint and respective customer selection information for each of a plurality of advertisers. The memory optionally has further computer-executable instructions stored thereon that, when executed by the processor, cause the processor to aggregate respective offers from each of the advertisers into a single offer.

Alternatively or additionally, in some implementations, the route is a shortest distance between the starting location and the destination. Alternatively or additionally, in some implementations, the route is a shortest by travel time between the starting location and the destination.

Alternatively or additionally, in some implementations, the step of determining a route between the starting location and the destination includes determining a plurality of different routes.

Alternatively or additionally, in some implementations, the memory has further computer-executable instructions stored thereon that, when executed by the processor, cause the processor to transmit the route to a device associated with the user.

According to another aspect, the present disclosure is directed to a system including a client device associated with a user; and a server computing device that is operably coupled to the client device via a network. The client device is configured to determine a location of the user. The server computing device includes a processor and a memory operably coupled to the processor. The memory has computer-executable instructions stored thereon that, when executed by the processor, cause the server computing device to: receive a starting location and a destination from the client device; determine a route between the starting location and the destination; and receive a waypoint and customer selection information, where the waypoint and the customer selection information are associated with an advertiser, and where the customer selection information differentiates between probable and improbable customers. The memory has further computer-executable instructions stored thereon that, when executed by the processor, cause the processor to: determine an alternative route between the starting location and the destination, where the alternative route includes the waypoint; determine, using the customer selection information, whether the user is a probable customer or an improbable customer; and if the user is an improbable customer, transmit the alternative route and an offer associated with the advertiser to the client device. Additionally, the client device is optionally further configured to monitor the user's location while travelling between the starting location and the destination; and transmit location data to the server computing device over the network. Additionally, the memory optionally has further computer-executable instructions stored thereon that, when executed by the processor, cause the server computing device to: receive the location data; confirm, using the location data, that the user reached the destination; and in response to the confirmation, transmit a token to the client device. Optionally, the token is at least one of a coupon, discount, rebate, or credit for goods or services associated with the advertiser.

According to yet another aspect, the present disclosure is directed to a system, including a processor; and a memory operably coupled to the processor. The memory has computer-executable instructions stored thereon that, when executed by the processor, cause the processor to: receive a starting location and a destination from a user; determine a route between the starting location and the destination; receive a waypoint associated with an advertiser; and determine an alternative route between the starting location and the destination, where the alternative route includes the waypoint. Additionally, the memory has further computer-executable instructions stored thereon that, when executed by the processor, cause the processor to: transmit the route to the user; transmit the alternative route and an offer associated with the advertiser to the user; receive a confirmation that the user reached the destination using the alternative route; and in response to the confirmation, transmit a token to the user. For example, the location data is acquired by a device associated with the user, and the location data is transmitted to the system via a network. Optionally, the token is at least one of a coupon, discount, rebate, or credit for goods or services associated with the advertiser.

According to yet another aspect, the present disclosure is directed to a system including a client device associated with a user; and a server computing device that is operably coupled to the client device via a network. The client device is configured to monitor the user's location while travelling between the starting location and the destination. The client device is optionally configured to: monitor the user's location while travelling between the starting location and the destination, and transmit location data to the server computing device over the network. The server computing device includes a processor and a memory operably coupled to the processor, where the memory has computer-executable instructions stored thereon that, when executed by the processor, cause the server computing device to: receive a starting location and a destination from the client device; determine a route between the starting location and the destination; receive a waypoint associated with an advertiser; determine an alternative route between the starting location and the destination, where the alternative route includes the waypoint; transmit the route to the client device; transmit the alternative route and an offer associated with the advertiser to the client device; receive the location data from the client device; and confirm, using the location data, that the user reached the destination using the alternative route; and in response to the confirmation, transmit a token to the client device. Optionally, the token is at least one of a coupon, discount, rebate, or credit for goods or services associated with the advertiser.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A is a flow chart of an example set of operations according to an implementation described herein.

FIG. 1B is a flow chart of an example set of operations according to another implementation described herein.

FIG. 2 illustrates a user interface displaying a portion of an original route and an offer (e.g., discount) associated with an alternative route according to an implementation described herein.

FIG. 3 illustrates a user interface displaying a portion of the alternative route including a waypoint on the alternative route according to an implementation described herein.

FIG. 4 illustrates a user interface displaying the alternate route between the starting point and destination and including the waypoint according to an implementation described herein.

FIG. 5 illustrates a user interface displaying two routes between the starting point and destination according to an implementation described herein. One route is the original route, and the other route is the alternate route including the waypoint.

FIG. 6 illustrates a user interface displaying a notification that hotel credit has been applied according to an implementation described herein.

FIG. 7 illustrates an example computing device upon which the methods described herein may be implemented.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for a map-based application, it will become evident to those skilled in the art that the implementations are not limited thereto, but are applicable for other systems and methods for targeting advertisements to prospective customers using price discrimination.

Throughout the present disclosure “advertiser” may refer to any entity (e.g., a business) that seeks to target advertisements such as an offer for goods and/or services to prospective customers of the advertiser. In the examples below, the advertiser is a hotel. It should be understood that a hotel is provided only as an example. This disclosure contemplates that advertisers can include, but are not limited to, hotels, motels, restaurants, gas or fuel stations, retailers, and/or other entities interested in enticing prospective customers to visit their businesses. Additionally, throughout the present disclosure “alternate route” and “alternative route” may be used interchangeably. The terms “starting point” and “starting location” may also be used interchangeably throughout the present disclosure.

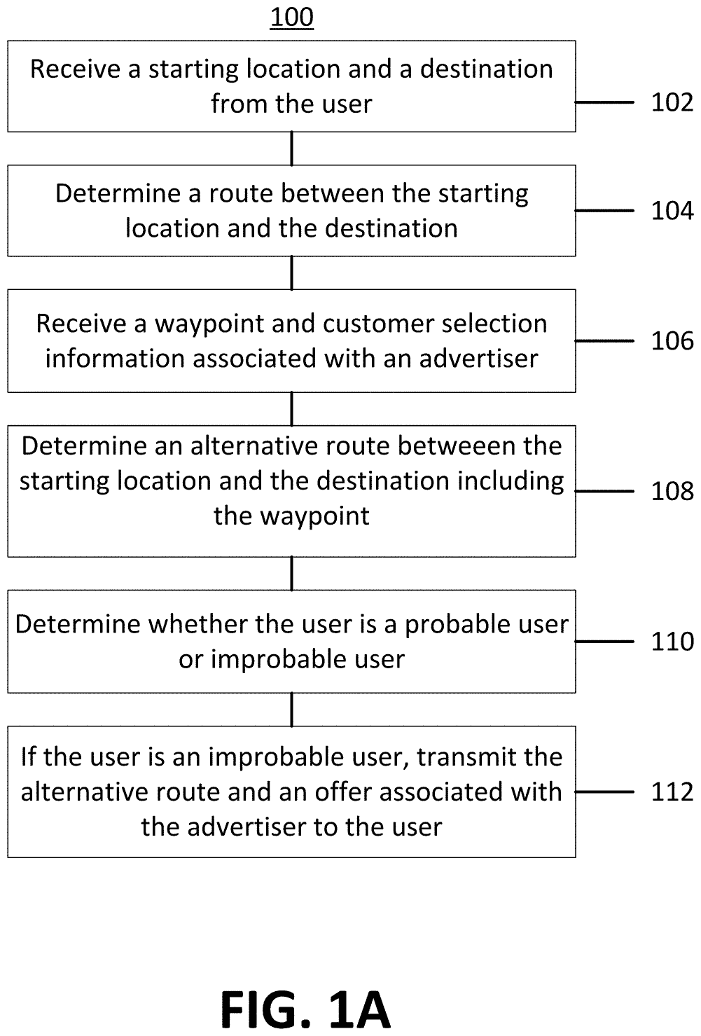

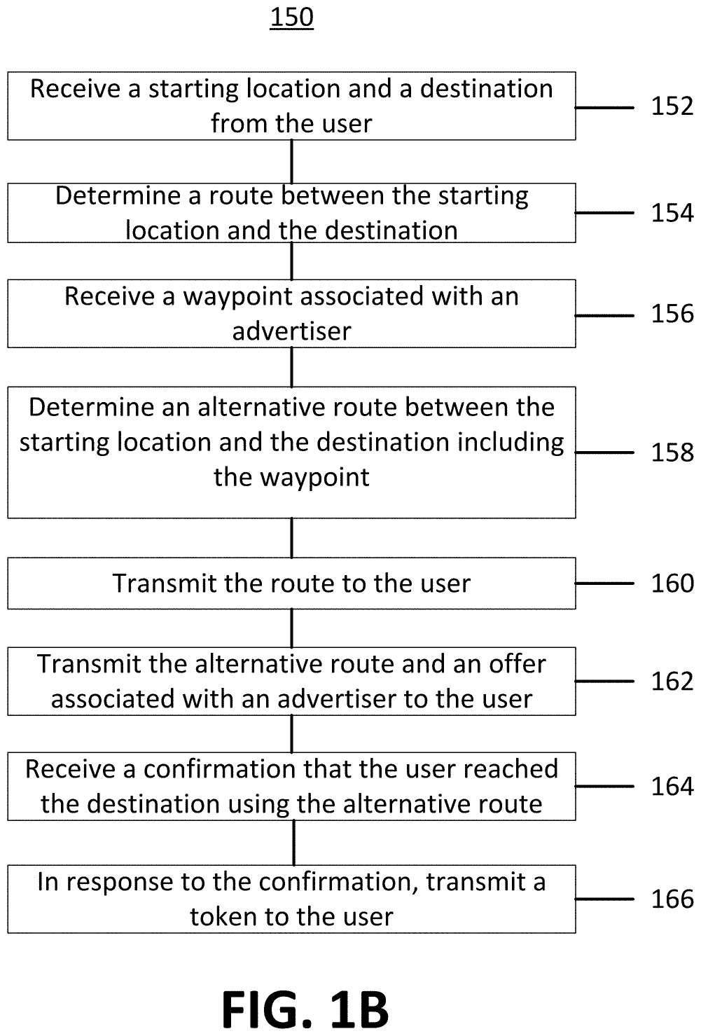

With reference to FIG. 1A, a flowchart 100 illustrating example operations according to an implementation of the present disclosure is shown. The operations shown in FIG. 1A can be used to differentiate between probable and improbable customers and transmit offers to improbable customers. In other words, one objective of the systems and methods described herein is to exclude certain users from receiving offers, for example persons who are already, or likely to become, a customer of a business. It should be understood that the business would just be cannibalizing profits by offering a discount to existing or highly probable customers of the business. The techniques described herein therefore target improbable customers of the business, which is different than conventional advertising systems and methods. Optionally, the value of the offer can be varied based on the likelihood or probability that the user will become a customer of the business. For example, there can be a continuum where the business does not offer any discount for a person who is going to be a customer with a probability of 100% but the business offers a large discount to a person who is going to be a customer with a probability of 0%. This is a form of price discrimination, where a certain subset of probable customers are excluded from receiving offers from a business.

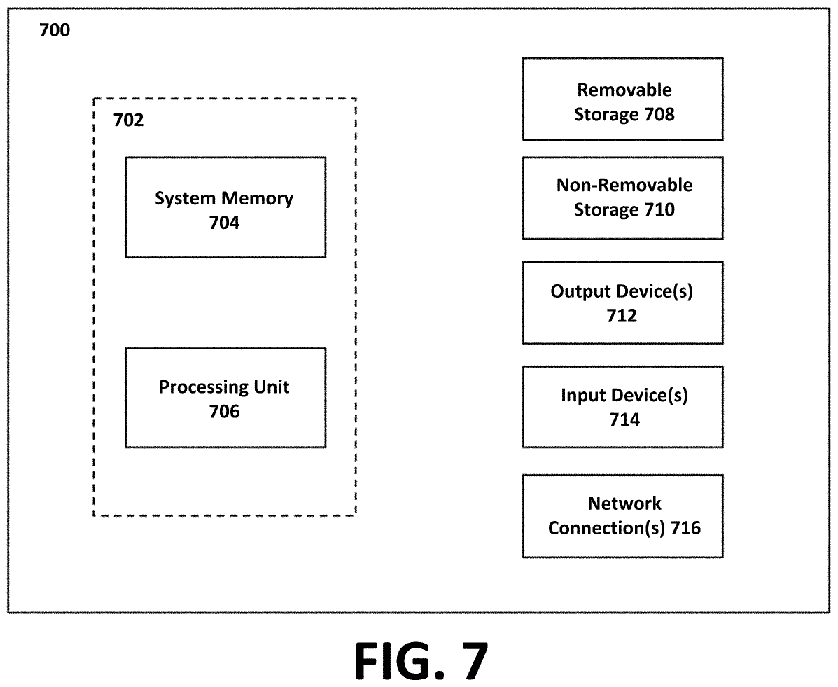

This disclosure contemplates that the example operations shown in FIG. 1A can be performed using a system such as a computing device (e.g., computing device 700 shown in FIG. 7). Alternatively or additionally, the computing device can be operatively coupled with a user's electronic device such as a smart phone or vehicle navigation system, for example. The computing device and user's electronic device discussed above can be coupled through one or more communication links. This disclosure contemplates the communication links are any suitable communication link. For example, a communication link may be implemented by any medium that facilitates data exchange including, but not limited to, wired, wireless and optical links. Example communication links include, but are not limited to, a local area network (LAN), a wireless local area network (WLAN), a wide area network (WAN), a metropolitan area network (MAN), Ethernet, the Internet, or any other wired or wireless link such as WiFi, WiMax, 3G, 4G, or 5G.

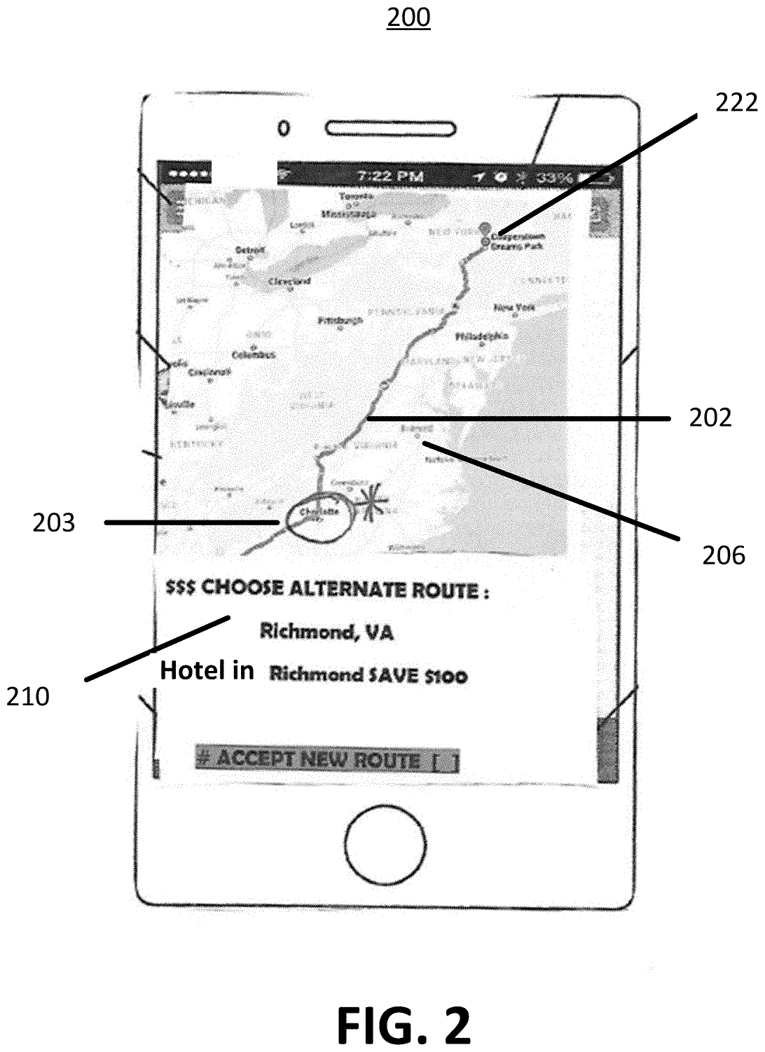

At step 102, a starting location and destination are received from a user. For example, the user can enter the starting location and destination into the user's electronic device, and this information can be transmitted to the system over a network. In the examples shown in FIGS. 2-6, the starting location is Alpharetta, Ga. and the destination is Cooperstown Dreams Park, Cooperstown, N.Y. It should be understood that these locations are provided only as examples. This disclosure contemplates that the starting location and destination can be other geographical locations.

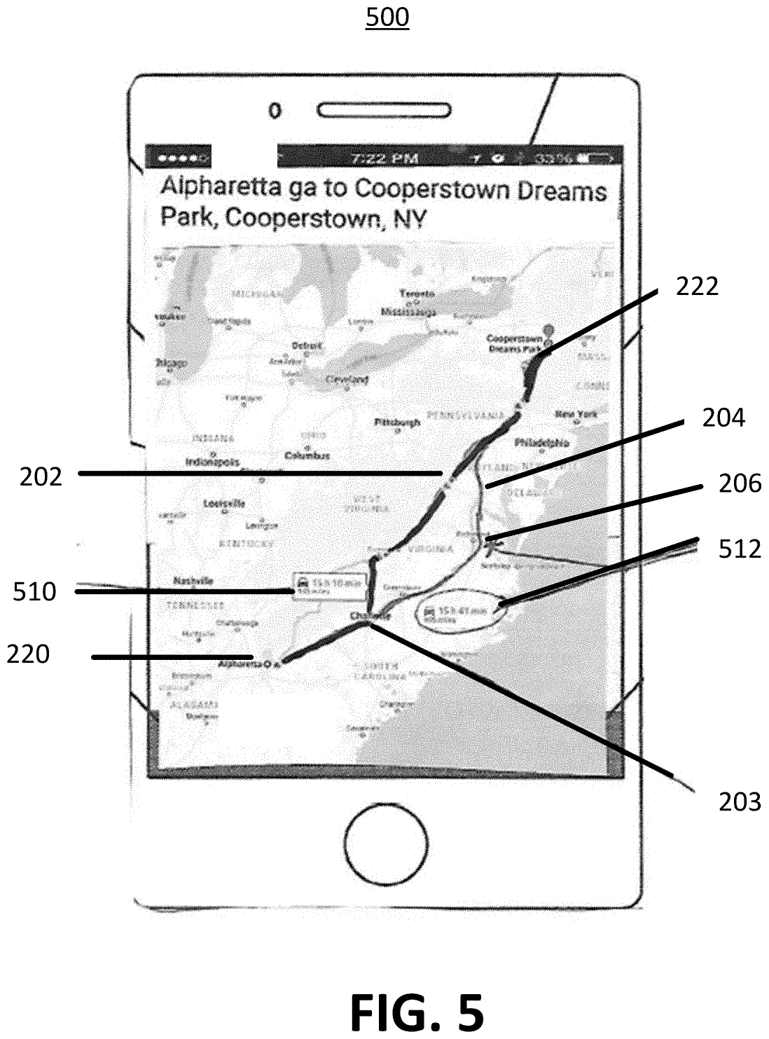

At step 104, a route between the starting location and the destination is determined. In the examples of FIGS. 2-6, this is referred to as the “original route.” The original route is illustrated, for example, in FIG. 5. In some implementations, the original route is a shortest distance between the starting location and the destination. Alternatively or additionally, in some implementations, the original route is a shortest by travel time between the starting location and the destination. This disclosure contemplates that the original route can be transmitted from the system to a user's electronic device and displayed on a user interface (e.g., as shown by FIGS. 2 and 5).

At step 106, a waypoint associated with an advertiser and customer selection information associated with the advertiser is received. Optionally, the advertiser provides the customer selection information to the system. As described herein, the customer selection information is used to differentiate between probable customers and improbable customers of the advertiser. One objective is to determine whether a person is an improbable customer of the advertiser, and if so, attempt to entice such person to visit the advertiser's place of business using an offer. As described herein, the offer can be a discount, coupon, credit, rebate, reduced price/rate, etc. In the examples of FIGS. 2-6, the waypoint is Richmond, Va. In these examples, the customer selection information differentiates between probable and improbable customers based a distance between the waypoint (Richmond, Va.) and the original route.

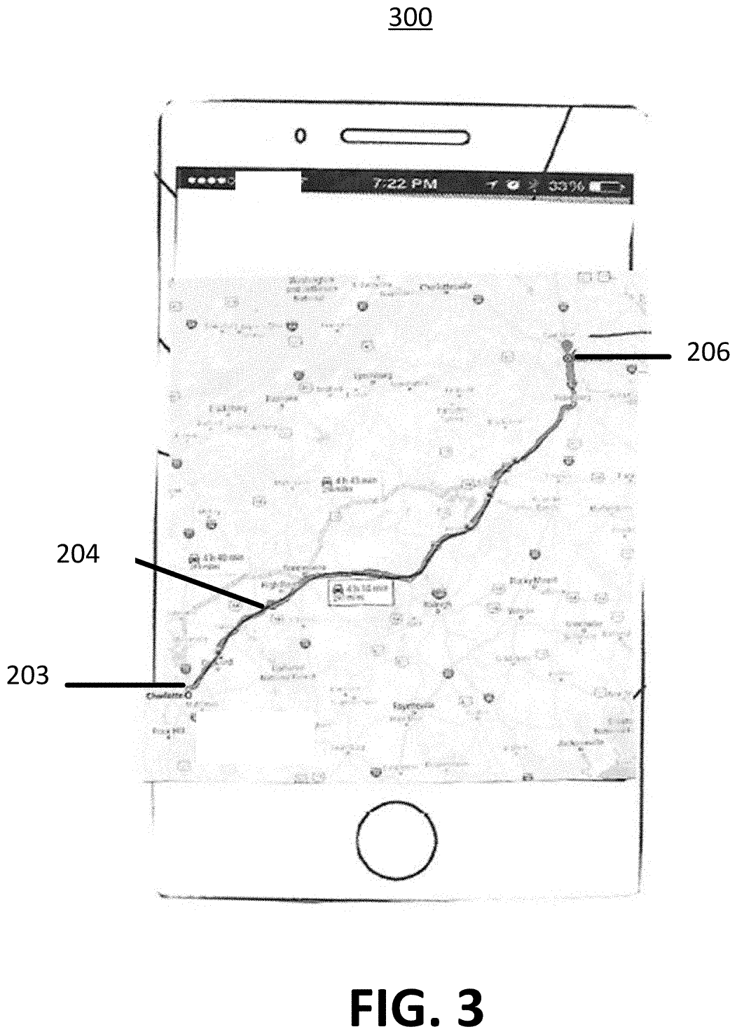

At step 108, an alternate route between the starting location and the destination including the waypoint is determined. In the examples shown in FIGS. 2-6, the starting location is Alpharetta, Ga. and the destination is Cooperstown Dreams Park, Cooperstown, N.Y. Additionally, the waypoint is Richmond, Va., which is not along the original route. In other words, the user would need to deviate from the original route to travel to Richmond, Va. The alternative route is illustrated, for example, in FIG. 5. This disclosure contemplates that the alternative route can be transmitted from the system to a user's electronic device and displayed on a user interface (e.g., as shown by FIGS. 3-6).

At step 110, a determination is made as to whether the user is a probable or improbable user of the advertiser. This determination can be based in part or entirely on the customer selection information and/or the alternative route. As described herein, the customer selection information can differentiate between probable and improbable customers based a distance between the waypoint (Richmond, Va.) along the alternative route and the original route. This disclosure contemplates that as distance between the waypoint along the alternative route and the original route increases, the probability of the user becoming a customer of the advertiser decreases. In other words, the user is less likely to deviate from the original route to travel to a waypoint with increasing distance from the original route. It therefore would require a larger incentive (e.g., larger discount, credit, rebate, etc.) to entice the user to deviate from the original route to visit the waypoint. Accordingly, the value of the offer can be variable in relation to the distance between the waypoint and the original route. As described below, distance is only provide as an example metric for determining the probability of a person becoming a customer of an advertiser.

At step 112, the alternative route and an offer associated with the advertiser is transmitted to the user. For example, the alternative route and the offer can be transmitted from the system to the user's electronic device over a network. This disclosure contemplates that the alternative route and the offer can be displayed on a user interface. This is shown, for example, by FIG. 2. The user is given the option to “accept” the offer, for example, using the user interface. Optionally, as described herein, the system can be configured to confirm whether the user travels from the starting location (Alpharetta, Ga.) to the ultimate destination (Cooperstown Dreams Park, Cooperstown, N.Y.) via the alternative route before the offer is honored by the advertiser. As described herein, this prevents a user from gaming the system, for example, by not providing the offer to a user who did not intend to travel between the starting location (Alpharetta, Ga.) and destination (Cooperstown Dreams Park, Cooperstown, N.Y.).

Additionally, the system can receive an acceptance of the offer from the user, and in response to the acceptance, the system can transmit a token to the user. This disclosure contemplates that the token is at least one of a coupon, discount, rebate, or credit for goods or services associated with the advertiser.

According to an implementation described herein, the system includes a client device (e.g., the user's electronic device) and a server computing device. The client device and server device can be connected via a network, and the server computing device can contain computer readable instructions that execute the operations illustrated in FIGS. 1A-1B, or additional operations.

Different types of customer selection information are possible. According to some implementations described herein, the customer selection information includes a threshold probability, where customers that are more likely than the threshold probability to become customers are classified as “probable customers” and customers less likely than the threshold probability to become customers are classified as “improbable customers.” The customer selection information can be selected or determined by the advertiser. Additionally, the threshold probability can be selected or determined by the advertiser. The system can also determine the probability of the user becoming a customer of the advertiser. According to some implementations, the customer selection information is used to determine the probability that the user will become a customer.

According implementations described herein, the probability that a user will be a customer is used by the system to determine whether to provide the user with an offer. As a non-limiting example, if a user has no (or very low) chance of becoming a customer, then that user can be offered the highest value offer. On the other hand, if a user is highly likely, or certain to be a customer, then the system can prevent transmission of an offer to such user. For those users in between, the value of the offer may vary. For example, the value of the offer can be higher for “improbable customers” than for “probable customers.” Optionally, if the user is a highly probable customer (e.g., a customer very likely to be a customer without receiving an offer), then the system can prevent the transmission of the offer to the user. The value of the offer can be scaled to the probability of the user becoming a customer. For example, users that are less probable customers of the advertiser can receive higher offers than users that are more probable customers of the advertiser. Similarly, users that have lower probabilities of becoming customers of the advertiser can receive more valuable offers than users that have higher probabilities of becoming customers of the advertiser. Optionally, in some implementations (e.g., see FIGS. 2-6), the distance between a waypoint and a shortest route travelled by a customer is used to differentiate between probable and improbable customers. It should be understood that distance is only used as an example. This disclosure contemplates using other customer selection information to differentiate between probable and improbable customers.

Some implementations described herein rely on information about the user's route to determine the value of the offer transmitted to the user. For example, the alternative route can include a waypoint that is distant from the original route (e.g., the shortest route between a starting point and destination by distance and/or time). The alternative route may be longer in duration or longer in distance than the original route. For example, implementations described herein can increase or decrease the value of the offer based on the alternative route length, alternative route travel time, and other information about the alternative route. One objective is to entice a user that is an improbable customer of the advertiser to deviate from the original route and use the alternative route when travelling to the destination. Alternatively or additionally, the length of the distance between the waypoint on the alternative route and the original route available to the user can also be used to determine the value of the offer. According to some implementations described herein, the user may be provided with more than one alternative route, and each of the alternative routes can have offers associated with that alternative route.

Further, in some implementations described herein, the value of the offer may depend on both the information about the alternative route, and the information about the probability that a user will be a customer. The system can optionally receive an acceptance of an offer from a user, and transmit a token to a user who has accepted the offer. The token can be a coupon, rebate, discount, or credit for goods or services associated with the advertiser.

The token can be transmitted by the system to the user immediately after the user accepts the offer, or at another time. For example, the token can be transmitted to the user upon the arrival by the user at the waypoint or the destination. The system may use information about the user's location, including whether or not the user is on the alternative route in order to determine whether or not to transmit a token to the user. Optionally, location data is global positioning system (GPS) data. It should be understood that GPS data is provided only as an example. The token can also be transmitted to the user after the system receives a confirmation that the user has reached the destination. The confirmation can include location data from the user's electronic device, and the confirmation can be transmitted from the user's electronic system to the system over a network.

In some implementations described herein, the system can receive a waypoint and customer selection information from each of a plurality of advertisers. The system can use the waypoint and customer selection information from multiple advertisers to aggregate multiple offers into a single offer. For example, respective offers from a hotel and a restaurant at a waypoint can be aggregated by the system into a single offer, which is presented to the user.

With reference to FIG. 1B, a flowchart 150 illustrating example operations according to another implementation of the present disclosure is shown. The operations shown in FIG. 1B can be used to confirm that a user travels between the starting location and destination. As described herein, the user is presented with an alternative route and offer that entices the user to travel via the alternate route. The systems and methods described herein target improbable customers, which is different than conventional advertising systems and methods. It is therefore possible to exclude certain users from receiving offers, for example persons who are already, or likely to become, a customer of a business. The operations of FIG. 1B prevent persons from “gaming” the system by using location information (e.g., GPS data) to verify the user's travel route. Accordingly, it is possible to ensure that the offer is made only to persons who started with a low probability of becoming a customer of the business and that reach the destination via the alternative route. This disclosure contemplates that the example operations shown in FIG. 1B can be performed using a system such as a computing device (e.g., computing device 700 shown in FIG. 7).

At step 152, a starting location and destination are received from a user. As described herein, the user can enter the starting location and destination into the user's electronic device, and this information can be transmitted to the system over a network. In the examples shown in FIGS. 2-6, the starting location is Alpharetta, Ga. and the destination is Cooperstown Dreams Park, Cooperstown, N.Y. It should be understood that these locations are provided only as examples. This disclosure contemplates that the starting location and destination can be other geographical locations.

At step 154, a route between the starting location and the destination is determined. In the examples of FIGS. 2-6, this is referred to as the “original route.” The original route is illustrated, for example, in FIG. 5. In some implementations, the original route is a shortest distance between the starting location and the destination. Alternatively or additionally, in some implementations, the original route is a shortest by travel time between the starting location and the destination. This disclosure contemplates that the original route can be transmitted from the system to a user's electronic device and displayed on a user interface (e.g., as shown by FIGS. 2 and 5).

At step 156 a waypoint associated with an advertiser is received. In the examples of FIGS. 2-6, the waypoint along an alternative route is Richmond, Va.

At step 158, an alternate route between the starting location and the destination including the waypoint is determined. In the examples shown in FIGS. 2-6, the starting location is Alpharetta, Ga. and the destination is Cooperstown Dreams Park, Cooperstown, N.Y. Additionally, the waypoint is Richmond, Va., which is distant from the original route. The alternative route is illustrated, for example, in FIG. 5. This disclosure contemplates that the alternative route can be transmitted from the system to a user's electronic device and displayed on a user interface (e.g., as shown by FIGS. 3-6).

At step 160, the original route is transmitted to the user. For example, the original route can be transmitted from the system to the user's electronic device over a network. This disclosure contemplates that the original route can be displayed on a user interface. This is shown, for example, by FIG. 5 which shows both the original route and alternative route presented to the user.

At step 162, the alternative route and an offer associated with the advertiser is transmitted to the user. For example, the alternative route and the offer can be transmitted from the system to the user's electronic device over a network. This disclosure contemplates that the alternative route and the offer can be displayed on a user interface. This is shown, for example, by FIG. 2. The user is given the option to “accept” the offer, for example, using the user interface.

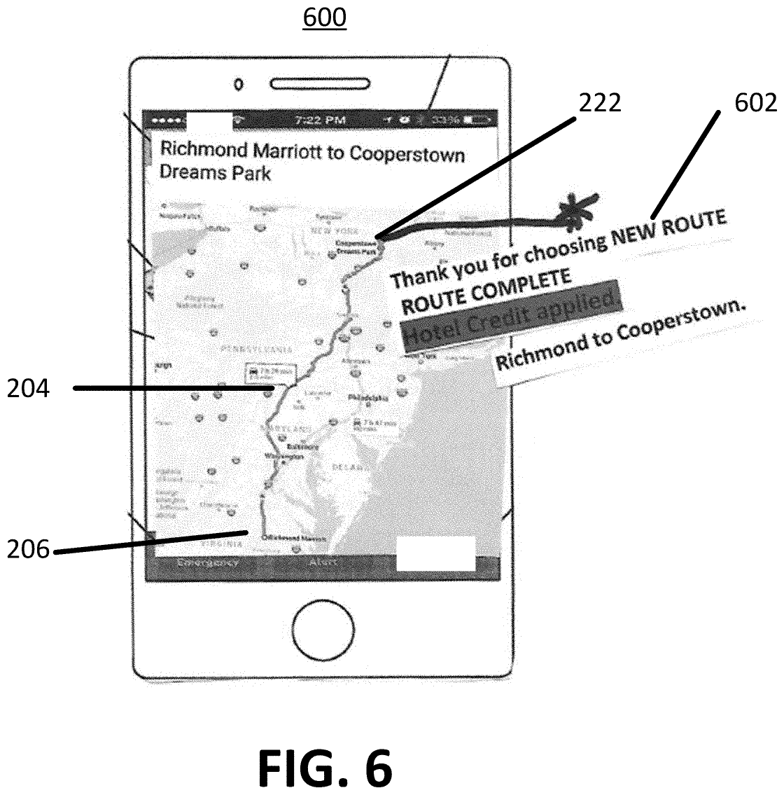

At step 164, the system receives a confirmation when the user has reached the ultimate destination via the alternative route. This is shown, for example, by FIG. 6, where the user receives a notification that the user has arrived at the destination (Cooperstown Dreams Park, Cooperstown, N.Y.). As described herein, the system may use information about the user's location, including whether or not the user has travelled between the starting point and destination by the alternative route in order to determine whether or not to transmit a token to the user. Optionally, location data is GPS data.

At step 166, the system can transmit a token to the user in response to receiving the confirmation in step 164. Optionally, the user can receive a notification that the token has been applied. This is shown, for example, by FIG. 6 where the user receives a notification that the hotel credit has been applied. In FIG. 6, the token is a hotel credit, but this disclosure contemplates that the token can be a coupon, rebate, discount, or credit for goods or services associated with the advertiser.

FIG. 2 depicts a user interface 200 that displays a notification 210 to the user suggesting an alternative route. As described herein, the user is travelling between Alpharetta, Ga. (starting location) and Cooperstown Dreams Park, Cooperstown, N.Y. (destination). The original route 202 can be the shortest route by distance between the starting location (not shown in FIG. 2) and the destination 222 and/or the shortest route by travel time between the starting location and the destination 222. Optionally, the original route 202 between the starting location and the destination 222 can be chosen from among a number of different routes. The original route 202 can be transmitted from one system to another, for example from a system such as a server computing device to a user device over a network. The interface 200 also includes a depiction of a portion of the original route 202 between the staring location and the destination 222. A waypoint 203 (Charlotte, N.C.) along the original route 202 is shown in FIG. 2. When the user reaches waypoint 203, the notification 210 suggesting the alternative route is provided to the user via the interface 200. The notification 210 includes an offer (e.g., discounted rate) for a hotel in Richmond, Va., which entices the user to travel to a waypoint 206 that is distant from the original route 202. This disclosure contemplates that the notification 210 can be transmitted to the user via a popup window in the user interface 200. Alternatively or additionally, the notification 210 can be transmitted by another means including, but not limited to, email, text message, etc. In other words, travelling via waypoint 206 requires a deviation from the original route 202. As described herein, the notification 210 is used to attract an improbable customer of the advertiser (e.g., hotel) to visit waypoint 206. Optionally, the value of the offer can be variable in relation to the distance between the waypoint 206 and the original route 202. For example, the farther waypoint 206 is from the original route 202, the higher the value of the offer. This disclosure contemplates that distance from the original route 202 can serve as the metric of the user's likelihood of becoming a customer of the advertiser (e.g., hotel).

FIG. 3 depicts a user interface 300 that displays a portion of the alternative route 204 between the waypoint 203 (Charlotte, N.C.) and waypoint 206 (Richmond, Va.). As described herein, the user is travelling between Alpharetta, Ga. (starting location) and Cooperstown Dreams Park, Cooperstown, N.Y. (destination). The user has opted to travel to the destination via the alternative route 204, which includes waypoint 206. As described with regard to FIG. 2, the user received a notification suggesting the alternative route 204 along with an offer for the hotel in Richmond, Va.

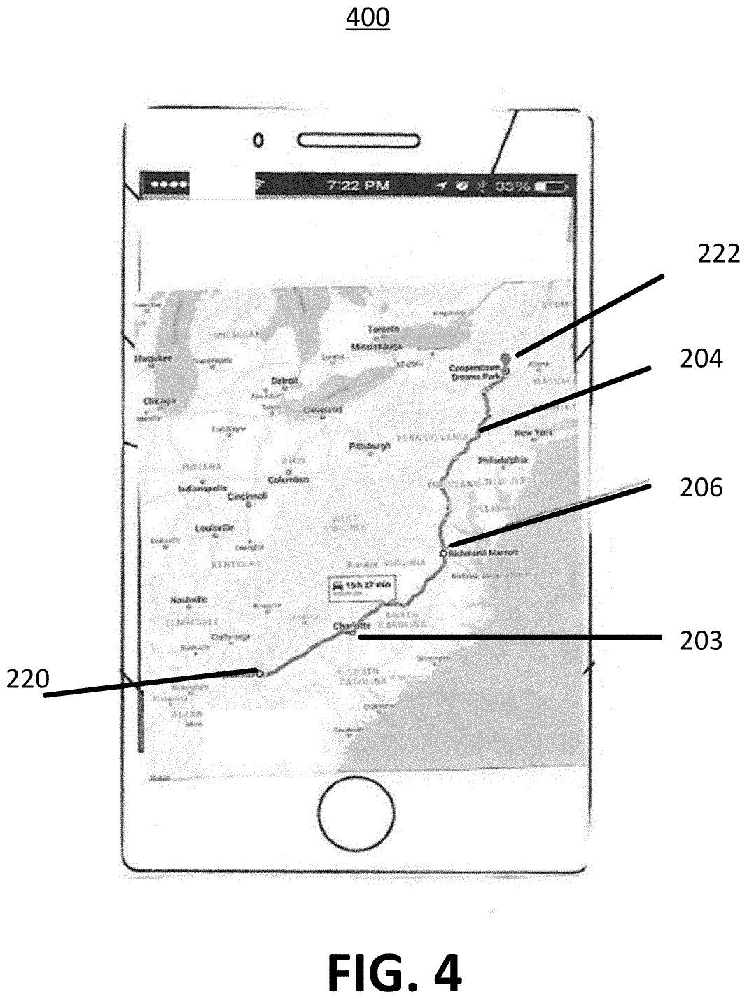

FIG. 4 depicts a user interface 400 that displays the alternate route 204 between the starting location 220 (Alpharetta, Ga.) and destination 222 (Cooperstown Dreams Park, Cooperstown, N.Y.). Both waypoint 203 (Charlotte, N.C.) and waypoint 206 (Richmond, Va.) are labeled in FIG. 4. As described above, the user has decided to deviate from the original route at waypoint 203 (Charlotte, N.C.) and proceed to destination 222 via waypoint 206 (Richmond, Va.).

FIG. 5 depicts a user interface 500 that displays both the original route 202 and the alternative route 204 between the starting location 220 (Alpharetta, Ga.) and destination 222 (Cooperstown Dreams Park, Cooperstown, N.Y.). Both waypoint 203 (Charlotte, N.C.) and waypoint 206 (Richmond, Va.) are labeled in FIG. 5. This disclosure contemplates that information about the routes can be provided on the user interface 500. For example, time and distance information 510 associated with the original route 202 and time and distance information 512 associated with the alternative route 204 can be displayed. It should be understood that time and distance information are provided only as examples. This disclosure contemplates that other information associated with the route(s) can be provided via the user interface 500. As described above, the user has decided to deviate from the original route at waypoint 203 (Charlotte, N.C.) and proceed to destination 222 via waypoint 206 (Richmond, Va.).

FIG. 6 depicts a user interface 600 with a notification 602 informing the user that the trip between the starting location (e.g., Alpharetta, Ga.) and destination (e.g., Cooperstown, N.Y.) via the waypoint (e.g., Richmond, Va.) along the alternative route has been completed and that the hotel credit has been applied. The interface 600 also includes a depiction of a portion of the alternative route 204 between the staring location (not shown in FIG. 6) and the destination 222 that the user has completed. The alternative route 204 includes the waypoint 206, which is the hotel in Richmond, Va. As described herein, in some implementations, the user must actually travel between the starting location (e.g., Alpharetta, Ga.) and destination (e.g., Cooperstown, N.Y.) via the alternative route 204 before the hotel credit is applied. FIG. 6 is an example of the confirmation/verification process.

According to some implementations described herein, the system includes tools for an advertiser to determine which users of the system should receive an offer for discounted goods and/or services. The offer can be provided by transmitting a token to a user. The advertiser can define customer section information, including customer behavior information. Customer information can include, but is not limited to, user location, user routes, user preferences, user purchasing history, and other information specified by the advertiser. In some implementations, customer information is distance between a waypoint and a travel route. For example, advertisers may target users whose routes are more than a minimum distance from the waypoint, but less than a maximum distance from the waypoint. The system can prevent users from receiving the token if the user fails to use the alternative route, or if the user fails to stop at the waypoint on the alternative route. Similarly, the system can prevent users from receiving the token if they fail to complete the alternative route.

According to some implementations described herein, the user can be a driver. As a non-limiting example, a driver can specify Manhattan as a destination and Atlanta as a starting location. Implementations described herein incentivize a user for completing alternative routes. The system can determine a fastest route, which, again as a non-limiting example, directs the driver to go through Alexandria, Va. An advertiser, for example, a hotel in Charlotte, N.C. can provide customer selection information to the system in order to target drivers that are traveling no closer than 50 miles from Charlotte but get within 100 miles of it. Other entities can be advertisers, for example an organization. Continuing with the same non-limiting example, a local Chamber of Commerce can provide customer selection information targeting travelers whose routes are no closer than 50 miles from Charlotte but within 100 miles of Charlotte. The system can provide an alert to the driver, whose route passes within the specified number of miles from Charlotte. The system can transmit the offer to the driver, in this non-limiting example an offer of a $150 credit if the driver stops at a specific hotel and passes through Charlotte. The credit may be funded by multiple advertisers, for example, $140 may have been offered by the hotel, and $10 offered by the Chamber of Commerce. If the user accepts the offer or offers, then the system can transmit the alternative route to the user including the waypoints associated with the offer or offers that the user has accepted. This allows entities such as companies, cities, or any other businesses to have the opportunity to pool funds to request the driver change his route and perhaps make a stop while on the new route.

The system can monitor the user's behavior, and transmit the token including the credit the driver based on the user's actions. Still continuing above non-limiting example, if the user only goes through Charlotte, the user is provided with the $10 credit associated with the Chamber of Commerce offer. If the user stops at the hotel, the user receives the $140 credit associated with the hotel's offer. If the user takes both actions, then the user receives $150. Further, one or both of the offers and associated tokens can be conditional on following the alternative route to the destination. As a non-limiting example, the system may reduce or eliminate the value of the token transmitted to a user who does not arrive at the destination or fails to meet other criteria.

Similarly, implementations described herein may also provide offers and waypoints associated with other types of offers than conventional advertisements for goods and services. For example, the system can be used to optimize routes and avoid traffic congestion. Continuing the prior example, a route provided to a user travelling from Atlanta to Manhattan may include routes through cities with traffic congestion. A local government can use information about the user's route to provide an offer to the user that is conditional on the user not passing through a certain congested area. As a non-limiting example, if the driver had planned to drive through Richmond, Va. at rush hour, a government body can use the system to transmit an offer to the user that incentivizes the user to go around Richmond and not drive through at rush hour. The system can aggregate or combine this offer with any other offers related to the route. The system can combine offers from companies, cities, or any entities to incentivize the user to use the alternative route and or stop at a waypoint on the alternative route. The offers, waypoints, and customer selection information may also be based in part on a time component. As another non-limiting example, the system can provide certain offers only at certain times of day, or only to certain users at certain times. Similarly, the customer selection information can include information about the user's profession. For example, the system may be configured to determine that a truck driver is a probable customer under different conditions than the ordinary user of the system.

Implementations described herein can also transmit offers to the user based on other actions related to the alternative route. For example, the alternative route can include a waypoint where the user either picks up or drops off a delivery. According to some implementations, the system can verify that the user has taken the actions related to the offer that the user has accepted. For example, the system can be configured to not transmit the token to the user until the system has received verification that the user has completed the action associated with the offer transmitted to the user. For example, if the offer is associated with stopping at a hotel located on the alternate route, the system can wait until receiving verification that the user has paid for the hotel room before transmitting the credit associated with stopping at the hotel. In some implementations described herein, the user can use the system to directly purchase goods or services associated with the offer, and the credit associated with the offer can be applied directly to the purchase price. Additionally, some implementations described herein can verify that the user has completed the alternative route (e.g., reached the destination via the alternative route) or taken another action, before transmitting the token or credit to the user. Additionally, different schemes for timing the credits provided to the user are possible. As a non-limiting example, the credits applied may be associated with completing particular waypoints of the alternative route. As another non-limiting example, the system can transmit a credit to the user for completing one or more waypoints of the alternative route, or the system may transmit partial credit to the user upon the user's arrival at a waypoint, and additional credit upon arriving at the destination.

It should be appreciated that the logical operations described herein with respect to the various figures may be implemented (1) as a sequence of computer implemented acts or program modules (i.e., software) running on a computing device (e.g., the computing device described in FIG. 7), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 7, an example computing device 700 upon which the methods described herein may be implemented is illustrated. It should be understood that the example computing device 700 is only one example of a suitable computing environment upon which the methods described herein may be implemented. Optionally, the computing device 700 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 700 typically includes at least one processing unit 706 and system memory 704. Depending on the exact configuration and type of computing device, system memory 704 may be volatile (such as random access memory (RAM)), non-volatile (such as read-only memory (ROM), flash memory, etc.), or some combination of the two. This most basic configuration is illustrated in FIG. 7 by dashed line 702. The processing unit 706 may be a standard programmable processor that performs arithmetic and logic operations necessary for operation of the computing device 700. The computing device 700 may also include a bus or other communication mechanism for communicating information among various components of the computing device 700.

Computing device 700 may have additional features/functionality. For example, computing device 700 may include additional storage such as removable storage 708 and non-removable storage 710 including, but not limited to, magnetic or optical disks or tapes. Computing device 700 may also contain network connection(s) 716 that allow the device to communicate with other devices. Computing device 700 may also have input device(s) 714 such as a keyboard, mouse, touch screen, etc. Output device(s) 712 such as a display, speakers, printer, etc. may also be included. The additional devices may be connected to the bus in order to facilitate communication of data among the components of the computing device 700. All these devices are well known in the art and need not be discussed at length here.

The processing unit 706 may be configured to execute program code encoded in tangible, computer-readable media. Tangible, computer-readable media refers to any media that is capable of providing data that causes the computing device 700 (i.e., a machine) to operate in a particular fashion. Various computer-readable media may be utilized to provide instructions to the processing unit 706 for execution. Example tangible, computer-readable media may include, but is not limited to, volatile media, non-volatile media, removable media and non-removable media implemented in any method or technology for storage of information such as computer readable instructions, data structures, program modules or other data. System memory 704, removable storage 708, and non-removable storage 710 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 706 may execute program code stored in the system memory 704. For example, the bus may carry data to the system memory 704, from which the processing unit 706 receives and executes instructions. The data received by the system memory 704 may optionally be stored on the removable storage 708 or the non-removable storage 710 before or after execution by the processing unit 706.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system, comprising:
a processor; and
a memory operably coupled to the processor, wherein the memory has computer-executable instructions stored thereon that, when executed by the processor, cause the processor to:
receive a starting location and a destination from a user;
determine a route between the starting location and the destination;
receive a waypoint and customer selection information, wherein the waypoint and the customer selection information are associated with an advertiser, and wherein the customer selection information differentiates between probable and improbable customers;
determine an alternative route between the starting location and the destination, wherein the alternative route includes the waypoint;
determine, using the customer selection information, whether the user is a probable customer or an improbable customer; and
if the user is an improbable customer, transmit the alternative route and an offer associated with the advertiser to the user.

2. The system of claim 1, wherein the memory has further computer-executable instructions stored thereon that, when executed by the processor, cause the processor to, if the user is a probable customer, prevent transmission of the offer to the user.

3. The system of claim 1, wherein the customer selection information differentiates between probable and improbable customers based a distance between the waypoint and the route.

4. The system of claim 3, wherein a value of the offer is variable in relation to the distance between the waypoint and the route.

5. The system of claim 1, wherein the customer selection information differentiates between probable and improbable customers based on a probability of becoming a customer of the advertiser.

6. The system of claim 5, wherein the customer selection information comprises a threshold probability that differentiates between probable and improbable customers.

7. The system of claim 6, wherein the threshold probability is selected by the advertiser.

8. The system of claim 5, wherein the memory has further computer-executable instructions stored thereon that, when executed by the processor, cause the processor to determine a probability of the user becoming a customer of the advertiser.

9. The system of claim 8, wherein a value of the offer is variable in relation to the probability of the user becoming a customer of the advertiser.

10. The system of claim 1, wherein the memory has further computer-executable instructions stored thereon that, when executed by the processor, cause the processor to:
receive an acceptance of the offer from the user; and
in response to the acceptance, transmit a token to the user.

11. The system of claim 1, wherein the memory has further computer-executable instructions stored thereon that, when executed by the processor, cause the processor to:
receive a confirmation that the user reached the destination; and
in response to the confirmation, transmit a token to the user.

12. The system of claim 11, wherein the confirmation comprises location data associated with the user.

13. The system of claim 12, wherein the location data is acquired by a device associated with the user, and wherein the location data is transmitted to the system via a network.

14. The system of claim 10, wherein the token is at least one of a coupon, discount, rebate, or credit for goods or services associated with the advertiser.

15. The system of claim 1, wherein receiving a waypoint and customer selection information comprises receiving a respective waypoint and respective customer selection information for each of a plurality of advertisers, and wherein the memory has further computer-executable instructions stored thereon that, when executed by the processor, cause the processor to aggregate respective offers from each of the advertisers into a single offer.

16. The system of claim 1, wherein the route is a shortest distance between the starting location and the destination.

17. The system of claim 1, wherein the route is a shortest by travel time between the starting location and the destination.

18. The system of claim 1, wherein determining a route between the starting location and the destination comprises determining a plurality of different routes.

19. The system of claim 1, wherein the memory has further computer-executable instructions stored thereon that, when executed by the processor, cause the processor to transmit the route to a device associated with the user.

20. A system, comprising:
a client device associated with a user, wherein the client device is configured to determine a location of the user; and
a server computing device operably coupled to the client device via a network, wherein the server computing device comprises a processor and a memory operably coupled to the processor, wherein the memory has computer-executable instructions stored thereon that, when executed by the processor, cause the server computing device to:
receive a starting location and a destination from the client device;
determine a route between the starting location and the destination;
receive a waypoint and customer selection information, wherein the waypoint and the customer selection information are associated with an advertiser, and wherein the customer selection information differentiates between probable and improbable customers;
determine an alternative route between the starting location and the destination, wherein the alternative route includes the waypoint;
determine, using the customer selection information, whether the user is a probable customer or an improbable customer; and
if the user is an improbable customer, transmit the alternative route and an offer associated with the advertiser to the client device.

21. The system of claim 20, wherein the client device is further configured to:
monitor the user's location while travelling between the starting location and the destination; and
transmit location data to the server computing device over the network, and wherein the memory has further computer-executable instructions stored thereon that, when executed by the processor, cause the server computing device to:
receive the location data;
confirm, using the location data, that the user reached the destination; and
in response to the confirmation, transmit a token to the client device.

22. The system of claim 21, wherein the token is at least one of a coupon, discount, rebate, or credit for goods or services associated with the advertiser.

23. A system, comprising:
a processor; and
a memory operably coupled to the processor, wherein the memory has computer-executable instructions stored thereon that, when executed by the processor, cause the processor to:
receive a starting location and a destination from a user;
determine a route between the starting location and the destination;
receive a waypoint associated with an advertiser;
determine an alternative route between the starting location and the destination, wherein the alternative route includes the waypoint;
transmit the route to the user;
transmit the alternative route and an offer associated with the advertiser to the user;
receive a confirmation that the user reached the destination using the alternative route; and
in response to the confirmation, transmit a token to the user.

24. The system of claim 23, wherein the confirmation comprises location data associated with the user.

25. The system of claim 24, wherein the location data is acquired by a device associated with the user, and wherein the location data is transmitted to the system via a network.

26. The system of claim 23, wherein the token is at least one of a coupon, discount, rebate, or credit for goods or services associated with the advertiser.

27. A system, comprising:
a client device associated with a user; and
a server computing device operably coupled to the client device via a network, wherein the client device is configured to:
monitor the user's location while travelling between the starting location and the destination, and
transmit location data to the server computing device over the network, and wherein the server computing device comprises a processor and a memory operably coupled to the processor, wherein the memory has computer-executable instructions stored thereon that, when executed by the processor, cause the server computing device to:
receive a starting location and a destination from the client device;
determine a route between the starting location and the destination;
receive a waypoint associated with an advertiser;
determine an alternative route between the starting location and the destination, wherein the alternative route includes the waypoint;
transmit the route to the client device;
transmit the alternative route and an offer associated with the advertiser to the client device;
receive the location data from the client device;
confirm, using the location data, that the user reached the destination using the alternative route; and
in response to the confirmation, transmit a token to the client device.

28. The system of claim 27, wherein the token is at least one of a coupon, discount, rebate, or credit for goods or services associated with the advertiser.
